(19) United States
(12) Patent Application Publication
(10) Pub. No.: US 2021/0372422 A1
(43) Pub. Date: Dec. 2, 2021

(54) VEHICLE PUMP DEVICE FOR PUMPING A LIQUID AND METHOD FOR HANDLING LEAKED LIQUID IN THE VEHICLE PUMP DEVICE

(71) Applicant: NIDEC GPM GMBH, Merbelsrod (DE)

(72) Inventors: Mario UNERTL, Weida (DE); Jakob SCHNITZER, Hildburghausen (DE)

(21) Appl. No.: 17/294,111

(22) PCT Filed: Nov. 13, 2019
(86) PCT No.: PCT/EP2019/081110

§ 371 Date: May 14, 2021

(30) Foreign Application Priority Data
Dec. 21, 2018 (DE) 10 2018 133 464.8

(51) Int. Cl. F04D 29/10; F04D 13/06; F04D 29/12

(52) U.S. Cl. CPC F04D 29/106; F05D 2260/6022; F04D 29/126; F04D 13/06

(57) ABSTRACT

A vehicle pump device for pumping a liquid, the vehicle pump device including a pump housing having a dry region for arranging electrical and/or electronic components and having a wet region for sucking in and discharging a liquid. An absorbent liquid-receiving apparatus for receiving and/or storing the leaked liquid is arranged in the dry region

### TECHNICAL FIELD

The invention relates to a vehicle pump device, which comprises a pump housing having a dry region for arranging electrical and/or electronic components and a wet region for sucking in and discharging a liquid. An absorbent liquid-receiving apparatus for receiving and/or storing a leaked liquid penetrating from the wet region into the dry region is arranged in the dry region. The invention also relates to a method for handling leaked liquid in the vehicle pump device.

### BACKGROUND

In glanded pumps, in which electrical and/or electronic components are arranged in a dry region which is separated off from a wet region, a leaked liquid can find its way into the dry region due to a leak. A draining device is frequently provided, which discharges the leak out of the dry region to the outside.

For example, the printed publication DE 20 2017 001 998 describes a water pump unit in the form of a glanded pump which has an impeller housing which contains a coolant in a sealing manner by means of a sealing element so that the coolant is isolated inside the impeller housing and cannot flow into a sealed region in which, e.g., a control device of the water pump unit is arranged. A cavity is provided in the sealed region, in which a drive end of an impeller shaft is received, which is arranged in the impeller housing in order to rotate an impeller. A rear wall of the housing in the sealed region has an outlet duct which runs outwardly from the cavity, via which outlet duct any cooling water particles which penetrate the sealing element can be let out.

In the case of devices, which detect a leak in liquid-carrying units, sensor-based warning systems and/or a collecting vessel for the liquids can, e.g., be provided in the unit in order to avoid damage by the leaked liquid.

For example, the printed publication DE 10 2004 040 106 B3 describes a universally usable device for detecting a leak. The device provides a depot in which an element is arranged in the immediate vicinity of a leak outlet, which element has at least one capillary gap or is an absorbent insert, e.g., a nonwoven fabric. The device comprises at least one sensor which detects and measures the leak and transmits it to an evaluation and signaling unit of the device.

In order to absorb liquids, the printed publication EP 0 842 953 A2 describes superabsorbent polymers which can be used, e.g., in agriculture, for hygiene products or for sheathing electrical cables.

The concept of preventing liquids escaping by means of polymeric absorbents is already known from the technical field of household appliances.

For example, the printed publication WO 2014/127842 A1, which is probably the closest prior art, describes a laundry drying machine having a cooling system and having an, e.g., polymeric absorbent which is suitable for absorbing liquid escaping from the cooling system.

### DESCRIPTION

The object, which forms the basis of the invention is to provide a functionally improved and durable vehicle pump device for pumping a liquid. This object is achieved by a vehicle pump device for pumping a liquid having the features of claim 1, by a vehicle having the vehicle pump device and by a method for handling leaked liquid in the vehicle pump device having the features of claim 12. Preferred or advantageous embodiments of the invention are set out in the subclaims, the following description and/or the appended figures.

A vehicle pump device is proposed, which is configured to pump a liquid in a vehicle, e.g., in a car or truck. The vehicle pump device is preferably configured as a glanded liquid pump.

For example, the liquid is a coolant, e.g., a water-based coolant, for cooling internal-combustion engines. In particular, the vehicle pump device is configured as a coolant pump, which can be integrated in the vehicle in order to pump the coolant.

The vehicle pump device comprises a pump housing, which is, e.g., formed from a cast alloy, in particular from a cast aluminum alloy. The pump housing comprises a dry region and a wet region which are preferably spatially separated from one another and, in particular, are sealed from one another. Electrical components, e.g., an electric motor, and/or electronic components, e.g., printed circuit boards and/or a control unit, can be and/or are arranged in the dry region. The electrical and/or electronic components have to be protected from the liquid, in particular in order to operate properly and to avoid damage.

The electric motor of the vehicle pump device is preferably provided in order to generate a torque and to drive a shaft of the vehicle pump device. For example, the pump housing is positively and/or non-positively connected to a motor housing surrounding the motor apparatus in the dry region.

The wet region is in particular configured to receive and to pass through the pumped liquid and/or the liquid to be pumped. In the context of the invention, it is preferable for at least one guide channel for guiding the pumped liquid and/or liquid to be pumped and for discharging the liquid to be comprised in the wet region. In particular, the liquid is sucked in, in the wet region, and flows through the at least one guide channel in order to be discharged.

Optionally, in addition, the vehicle pump device comprises a rotatable impeller for sucking in, moving and/or displacing the pumped liquid and/or liquid to be pumped within the wet region, in particular in the at least one guide channel. For this purpose, the impeller is arranged at the end of the shaft projecting into the wet region.

During the operation of the vehicle pump device, it can happen that the pumped liquid and/or liquid to be pumped finds its way from the wet region into the dry region as a liquid leak due to a leak within the pump housing. For example, a sealing apparatus which seals the wet region with respect to the dry region has a leak, for functional reasons, due to wear and/or contaminations during the operation of the vehicle pump device, by means of which leak the liquid leak can penetrate into the dry region. It is especially the case with glanded liquid pumps that the pumped liquid and/or liquid to be pumped must be prevented from coming into contact with the electrical and/or electronic components in the dry region, in order to avoid damage.

According to the invention, it is provided that an absorbent liquid-receiving apparatus for receiving and/or storing the leaked liquid is arranged in the dry region of the vehicle pump device, which penetrates from the wet region into the dry region. The liquid-receiving apparatus is preferably configured to suck up the leaked liquid and/or to store it therein.

For example, the liquid-receiving apparatus is configured as at least one sponge, stopper, bag, as a washer and/or as a foam part. The liquid-receiving apparatus can, e.g., also be in the form of loose small parts.

The absorbent liquid-receiving apparatus preferably comprises liquid-absorbing polymers, for example so-called superabsorbent polymers (SAP). These are in particular plastic granules which have very good liquid absorption capacities. In particular, the liquid-absorbing polymers can absorb and store a weight of leaked liquid which is many times, in particular 50 to 300 times, their own weight, by means of osmotic pressure as a function of the free ionic content, by forming a hydrogel by way of example. In particular, the sponge, the stopper, the bag, the washer, the foam part and/or the loose small parts are equipped with the liquid-absorbing polymers.

It is advantageous that the leaked liquid can be sucked up and/or absorbed and safely taken into storage and/or stored directly by the absorbent liquid-receiving apparatus in the dry region. In particular, damage to the electrical and/or electronic components arranged in the dry region by the leaked liquid penetrating into the dry region can be avoided by the liquid-receiving apparatus.

In a preferred embodiment of the invention, a collecting chamber is arranged in the dry region. The collecting chamber is preferably provided and/or configured to receive the leaked liquid. The collecting chamber forms a portion of the dry region and is enclosed in a liquid-tight manner with respect to a remaining portion of the dry region or with respect to the remaining dry region. In order to enclose the collecting chamber with respect to the remaining portion of the dry region, the vehicle pump device preferably comprises a closure lid. In particular, the closure lid is placed on at least one boundary wall of the collecting chamber so that the collecting chamber is closed in a liquid-tight manner with respect to the remainder of the drying chamber.

Optionally, in addition, the collecting chamber is enclosed in a liquid-tight manner with respect to the external surroundings of the vehicle pump device which is arranged in particular outside of the pump housing and the motor housing. The dry region is preferably configured so that it is free of any draining device. In particular, no device for draining to the outside, which connects the collecting chamber to the external surroundings in order to make it possible for the leaked liquid to drain to the outside, is provided in the dry region. Specifically, the leaked liquid is not discharged into the external surroundings of the vehicle pump device.

It is particularly preferred that the liquid-receiving apparatus is arranged in the collecting chamber. The advantage of this is that the leaked liquid introduced into the collecting chamber can be received and stored directly by the liquid-receiving apparatus. In particular, the leaked liquid can consequently remain in the collecting chamber over the entire lifetime of the vehicle pump device and does not have to be discharged.

In the context of the invention, it is preferred that the vehicle pump device comprises the shaft. The shaft can preferably be rotated about an axis of rotation, wherein it can in particular be driven and/or is driven by the electric motor. The shaft is preferably received in the pump housing and/or is surrounded, in sections, by the pump housing. Specifically, the shaft extends from the dry region into the wet region of the pump housing. In particular, the impeller is arranged at the end of the shaft in the wet region. The shaft is optionally configured to transmit the torque to the impeller so that said impeller rotates and moves the liquid in the wet region to pass through the at least one guide channel. In particular, the liquid in the wet region is sucked in and discharged by the rotating impeller.

A preferred implementation of the invention provides that the pump housing has a housing portion in the dry region. The housing portion in the dry region preferably extends axially at least in sections along the shaft. For example, the housing portion is realized in design terms as a hollow cylinder. In particular, the housing portion forms a bearing seat for the shaft. For example, a receiving sleeve is positively arranged inside the bearing seat, in particular in a cavity of the hollow cylinder, inside which receiving sleeve the shaft is rotatably mounted on at least one bearing apparatus. The at least one bearing apparatus is, e.g., at least one roller bearing, e.g., a first and second roller bearing, which can be configured as ball or roller bearings. In particular, the balls or rollers of the roller bearing roll on an inner peripheral surface of the receiving sleeve and support the rotation of the shaft by reducing the frictional resistance.

Optionally, in addition, the housing portion of the pump housing surrounds a sealing chamber in the dry region. The sealing chamber in the dry region is preferably joined to the bearing seat in the axial direction. The shaft preferably protrudes from the bearing seat and directly into the sealing chamber. A sealing apparatus configured as a sealing ring is preferably provided, which surrounds the shaft and seals the bearing seat with respect to the sealing chamber.

In a preferred embodiment of the invention, the shaft projects from the sealing chamber arranged in the dry region into the wet region of the pump housing. A further sealing apparatus is preferably provided between the sealing chamber and the wet region. For example, the further sealing apparatus is configured as a mechanical seal which is in engagement with the shaft and/or is seated on the shaft. The further sealing apparatus can seal the sealing chamber with respect to the wet region. For functional reasons and/or due to the wear or the contamination of the further sealing apparatus, it can however happen that, during the operation of the vehicle pump device, a leak occurs in the further sealing apparatus, due to which the leaked liquid can penetrate from the wet region into the dry region, in particular into the sealing chamber.

In a possible design configuration of the invention, at least one drainage channel for the leaked liquid is introduced into the housing portion, in particular at the point where the housing portion surrounds the sealing chamber. Optionally, the at least one drainage channel makes it possible for the leaked liquid to drain out of the sealing chamber. For example, three drainage channels are introduced in the housing portion, which are arranged offset from one another by 120 degrees about the axis of rotation. As a result, the leaked liquid can drain evenly in three directions.

In a particularly preferred configuration of the invention, the at least one drainage channel leads from the sealing chamber into the collecting chamber, in particular directly into the collecting chamber. It is particularly preferable, in the context of the invention, for the collecting chamber to be arranged adjacent to the housing portion, in particular adjacent to the bearing seat and/or to the sealing chamber. The collecting chamber preferably surrounds the housing portion radially.

The liquid-receiving apparatus can, if it is, e.g., configured annularly, be arranged in the collecting chamber and can surround the housing portion. The liquid-receiving apparatus can be arranged in a scattered manner in the collecting chamber in the form of loose small parts.

By way of example, the liquid-receiving apparatus can completely surround the housing portion, preferably in a contacting manner, as the sponge, the foam part and/or the washer. Alternatively or, optionally, additionally, multiple liquid-receiving apparatuses configured as bags are arranged in a scattered manner in the collecting chamber, in particular in the mouth region of the at least one drainage channel. If the liquid-receiving apparatus is configured as the at least one stopper, this can be inserted into the mouth of the at least one drainage channel.

It is advantageous that the leaked liquid can be conducted from the sealing chamber directly into the collecting chamber and, as a result, the leaked liquid can be prevented from penetrating even further into the drying chamber and damaging the electrical and/or electronic components. Further drainage ducts for the leaked liquid into the external surroundings of the vehicle pump device are not necessary, in particular due to the liquid-receiving apparatus arranged in the collecting chamber. As a result, further leaks in the pump housing can be avoided and installation space can be saved.

The discharging apparatus for discharging the leaked liquid into the external surroundings of the vehicle pump device is not necessary. In particular, the leaked liquid does not have to be released into the surroundings in a liquid form under the action of pressure and/or the influence of temperature. The advantage of this is that the risk of the environment being polluted by the leaked liquid can be prevented.

A vehicle having the vehicle pump device forms a further subject-matter of the invention. For example, the vehicle is configured as a car or as a truck. The vehicle pump device is preferably integrated as a coolant pump into the vehicle in order to pump the coolant and to cool the internal-combustion engine. In particular, in the case of a vehicle driven by an electric motor, the power electronics, an electric motor and a battery of the vehicle can be cooled by means of a cooling system in which the vehicle pump device is integrated as a coolant pump.

A method for handling leaked liquid in a vehicle pump device according to the previous description and/or according to claims 1 to 10 forms a further subject-matter of the invention.

In the context of the method, the absorbent liquid-receiving apparatus sucks up the leaked liquid penetrating from the wet region into the dry region and stores it and/or takes it into storage. In particular, the leaked liquid is sucked up, received, taken into storage and/or stored in the dry region by the absorbent liquid-receiving apparatus.

Furthermore, it is preferable, in the context of the method, for the liquid-receiving apparatus to be arranged in the collecting chamber. In particular, the leaked liquid is discharged into the collecting chamber. Specifically, the leaked liquid remains permanently in the collecting chamber, in particular confined in the liquid-receiving apparatus. The process of discharging leaked liquid into the external surroundings of the vehicle pump device is preferably dispensed with.

Further features, advantages and effects of the invention are set out in the following description of a preferred exemplary embodiment of the invention, wherein:

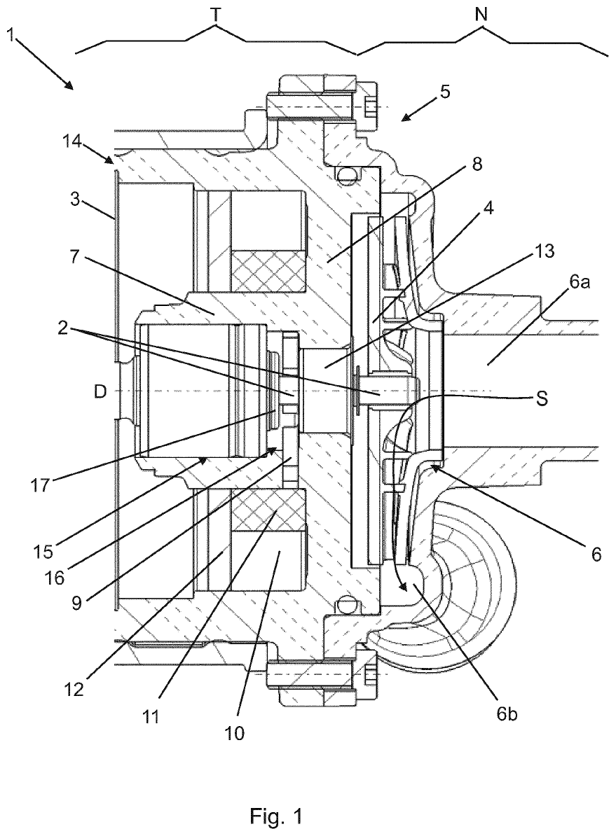

FIG. 1 shows a cross-section of a part of a vehicle pump device having a pump housing and having a shaft.

FIG. 1 depicts a part of a vehicle pump device 1 in a cross-section, the intersecting line of which runs perpendicular to an axis of rotation D of a shaft 2 of the vehicle pump device 1.

The vehicle pump device 1 is configured to pump a liquid as a glanded pump. The liquid to be pumped and/or the liquid pumped by the vehicle pump device 1 can, e.g., be a water-based coolant. For example, the vehicle pump device 1 is configured as a coolant pump in a vehicle, e.g., in a car or truck. In particular, in the case of a vehicle driven with an electric motor, the power electronics, an electric motor and a battery of the vehicle can be cooled via a cooling system, in which the vehicle pump device is integrated as a coolant pump.

The vehicle pump device 1 has an indicated motor apparatus 3, in particular an electric motor, for generating a torque. It can also have further electrical and/or electronic components such as, e.g., printed circuit boards or a control unit. The vehicle pump device 1 comprises a shaft 2 driven by the motor apparatus 3, which rotates and/or can rotate about an axis of rotation D. An impeller 4, which rotates and/or can rotate with the shaft 2, is arranged in a non-rotational manner at the end of the shaft 2.

The vehicle pump device 1 has a pump housing 5. The pump housing 5 has a wet region N and a dry region T. The dry region T is spatially separated from the wet region N by a separating wall 8 of the pump housing 5.

The wet region N is configured to receive and pass through the liquid to be pumped and/or the pumped liquid. It comprises at least one guide channel 6, in particular an axially running suction pipe 6a, in which the liquid is sucked in by means of the rotating impeller 4 and is pressed in a radial flow direction S into a drain pipe 6b, through which the liquid can drain to outside the pump device 1 into a collecting vessel.

The dry region T serves to receive the motor apparatus 3 and the further electrical and/or electronic components, e.g., the printed circuit boards and/or the control unit. In order to avoid damage, these have to be protected from contact with the liquid to be pumped and/or the pumped liquid and are therefore arranged in the dry region T.

The shaft 2 is coupled to an output of the motor apparatus 3 and extends axially through the dry region T. The shaft 2 projects into the wet region N through a recess in the separating wall 8. The impeller 4 for sucking in and displacing the liquid in the at least one guide channel 6 is arranged at the end of the shaft 2.

A sealing apparatus 13 configured as a mechanical seal is arranged on the shaft 2 in the recess of the separating wall 8. The sealing apparatus 13 is intended to seal the wet region N with respect to the dry region T and to prevent the liquid to be pumped and/or the pumped liquid from penetrating from the wet region N into the dry region T. The sealing apparatus 13 is provided to protect the motor apparatus 3 and the other electrical and/or electronic components from contact with the liquid to be pumped and/or the pumped liquid in order to avoid damage. However, signs of wear and/or contamination and, ultimately, also a function-related leak at the sealing apparatus 13 can occur during the operation of the vehicle pump device 1. A sealing effect of the sealing apparatus 13 is impaired by the leak, so that leaked liquid can penetrate from the wet region N into the dry region T.

The pump housing 5 has an axially running hollow cylindrical housing portion 7 in the dry region T. The housing portion 7 forms a bearing seat 15 for a rotating mounting of the shaft 2. A sleeve is positively received in the bearing seat 15, within which sleeve the shaft 2 is rotatably mounted on two roller bearing apparatuses, the roller bearings of the shaft 2 roll on an inner peripheral surface of the sleeve in order to reduce friction. The roller bearings can be configured as ball or roller bearings.

In the drying chamber T, the housing portion 7 also surrounds a hollow cylindrical sealing chamber 16 which is directly joined to the bearing seat 15 in the axial direction. The bearing seat 15 is sealed with respect to the sealing chamber 16 by a further sealing apparatus 17 which is configured as a sealing ring. The sealing chamber 16 is sealed with the sealing apparatus 13 with respect to the wet region N.

A collecting chamber 10 is arranged in the dry region T adjoining the housing portion 7. The collecting chamber 10 surrounds the housing portion 7 completely radially. Consequently, the dry region T comprises the collecting chamber 10 as the first portion and the remaining part of the dry region T as the remaining portion. The collecting chamber 10 is closed in a liquid-tight manner with respect to the remaining portion of the dry region T with a closure lid 12. No connection to the external surroundings of the vehicle pump device 1, in particular outside of the pump housing 5 and a motor housing 14 of the motor apparatus 3 is provided either, the motor housing 14 being able to form an integral part of the pump housing 5. In particular, the collecting chamber 10 is enclosed in a liquid-tight manner with respect to the external surroundings and with respect to the remaining portion of the dry region T.

The collecting chamber 10 is fluidically connected to the sealing chamber 13 via at least one drainage channel 9, e.g., via three drainage channels 9, which are each arranged offset from one another by 120 degrees about the axis of rotation D. The at least one drainage channel 9 is provided to discharge the leaked liquid, which finds its way from the wet region N into the dry region T, in particular into the sealing region 13, due to the leak in the sealing apparatus 13, into the collecting chamber 10.

An absorbent liquid-receiving apparatus 11 for absorbing and storing the leaked liquid is arranged in the collecting chamber 10. The liquid-receiving apparatus 11 comprises liquid-absorbing polymers, in particular so-called superabsorber polymers (SAP), which are plastic granules which have extensive liquid absorption capacities. The polymers can absorb and store a weight of liquid which is many times, in particular 50 to 300 times, their own weight, by means of osmotic pressure as a function of the free ionic content, by forming a hydrogel.

The liquid-receiving apparatus 11 is configured as a circular sponge, foam part or washer equipped with the polymers, which completely surrounds the housing portion 7 and/or rests on the latter. Alternatively, the liquid-receiving apparatus 11 can be configured as at least one bag filled with the polymers, preferably as multiple bags, which are arranged in a scattered manner in the collecting chamber 10. In addition, the configuration of the liquid-receiving apparatus 11 as at least one stopper equipped with the polymer is possible, which stopper can be arranged, e.g., in a mouth of the at least one drainage channel 9.

Consequently, the liquid leak can be sucked up and/or absorbed directly by the liquid-receiving apparatus 11.

It is advantageous that the liquid leak does not have to be discharged outside of the pump housing 3. Consequently, it is possible to dispense with the arrangement of a discharging apparatus and/or a collecting vessel outside of the vehicle pump device 1. In particular, this can save installation space, weight and/or costs. Furthermore, it is advantageous that the possibility of dispensing with the discharge of the leaked liquid into the external surroundings of the vehicle pump device 1 means that pollution of the environment by the leaked liquid can be prevented.

### LIST OF REFERENCE NUMERALS

1 Vehicle pump device
2 Shaft
3 Motor apparatus
4 Impeller
5 Pump housing
6 Guide channel
6a Suction pipe
6b Drain pipe
7 Housing portion
8 Separating wall
9 Drainage channel
10 Collecting chamber
11 Liquid-receiving apparatus
12 Closure lid
13 Sealing apparatus
14 Motor housing
15 Bearing seat
16 Sealing chamber
17 Sealing apparatus
D Axis of rotation
N Wet region
S Flow direction
T Dry region

1-15. (canceled)

16. A vehicle pump device for pumping a liquid, comprising: a pump housing having a dry region for arranging electrical and/or electronic components and having a wet region for sucking in and discharging a liquid; and, an absorbent liquid-receiving apparatus for receiving and/or storing a leaked liquid penetrating from the wet region into the dry region is arranged in the dry region.

17. The vehicle pump device according to claim 16, wherein the absorbent liquid-receiving apparatus is configured as at least one sponge, foam part, stopper, bag or as at least one washer.

18. The vehicle pump device according to claim 16, wherein the absorbent liquid-receiving apparatus comprises liquid-absorbing polymers.

19. The vehicle pump device according to claim 16, wherein a collecting chamber for receiving the leaked liquid is arranged in the dry region, the collecting chamber forming a portion of the dry region and the collecting chamber being enclosed in a liquid-tight manner with respect to another portion of the dry region and with respect to external surroundings of the vehicle pump device.

20. The vehicle pump device according to claim 19, wherein the liquid-receiving apparatus is arranged in the collecting chamber.

21. The vehicle pump device according to claim 19, wherein the pump housing comprises a circular-cylindrical housing portion in the dry region, the housing portion forming a bearing seat for a shaft and surrounding a sealing chamber adjoining the bearing seat in an axial direction, the housing portion being surrounded radially by the collecting chamber.

22. The vehicle pump device according to claim 21, wherein the shaft extends through the sealing chamber into the wet region, the vehicle pump device further comprising a sealing apparatus that seals the sealing chamber with respect to the wet region, at least one drainage channel for the leaked liquid being introduced into the housing portion, which leaked liquid penetrates from the wet region into the sealing chamber due to a leak in the sealing apparatus, the at least one drainage channel leading from the sealing chamber into the collecting chamber.

23. The vehicle pump device according to claim 22, wherein three drainage channels, which are arranged offset from one another by 120 degrees about the shaft, are introduced in the housing portion.

24. The vehicle pump device according to claim 21, wherein the liquid-receiving apparatus is arranged adjoining the housing portion and/or surrounds the housing portion at least partially.

25. The vehicle pump device according to claim 24, wherein the liquid-receiving apparatus surrounds the housing portion completely.

26. The vehicle pump device according to claim 16, wherein the vehicle pump device is an electrical coolant pump for pumping coolant of a vehicle.

27. A vehicle having the vehicle pump device according to claim 16.

28. A method for handling leaked liquid in a vehicle pump device according to claim 16, comprising the step of sucking up, receiving, taking into storage and/or storing, using the absorbent liquid-receiving apparatus, leaked liquid penetrating from the wet region into the dry region.

29. The method according to claim 28, wherein the liquid-receiving apparatus is arranged in the collecting chamber.

30. The method according to claim 28, including discharging the leaked liquid into the collecting chamber.

31. The method according to claim 30, wherein the leaked liquid remains permanently in the collecting chamber.
